(19) United States
(12) Patent Application Publication
(10) Pub. No.: US 2011/0216021 A1
(43) Pub. Date: Sep. 8, 2011

(54) INPUT APPARATUS

(75) Inventor: Atsushi MAEDA, Nagoya-shi (JP)

(73) Assignee: BROTHER KOGYO KABUSHIKI KAISHA, Nagoya-shi (JP)

(21) Appl. No.: 13/018,397

(22) Filed: Jan. 31, 2011

(30) Foreign Application Priority Data
Mar. 4, 2010 (JP) 2010-048000

(51) Int. Cl. G06F 3/041

(52) U.S. Cl. 345/173

(57) ABSTRACT

An input apparatus including: a display device which displays operational images; a touch detection device which detects a presence of a touch of an input object on the displayed operational images; an operational-image specifying section which specifies each operational image the input object has touched on the basis of the presence of the touch on the operational images; an operational-image number judging section which judges whether two or more operational images have been specified or not; a selected-direction determining section which determines a direction selected by a direction selecting operation on a condition that two or more of the plurality of operational images have been specified; and an operational-image determining section which determines one of the two or more operational images specified by the operational-image specifying section as a selected operational image of the input apparatus on the basis of the direction determined by the selected-direction determining section.

### CROSS REFERENCE TO RELATED APPLICATION

The present application claims priority from Japanese Patent Application No. 2010-048000, which was filed on Mar. 4, 2010, the disclosure of which is herein incorporated by reference in its entirety.

### BACKGROUND OF THE INVENTION

1. Field of the Invention

The present invention relates to an input apparatus.

2. Description of the Related Art

There is conventionally known various apparatuses in each of which a user operates or touches an operational image displayed on a display panel with an input object such as his or her finger or a pen to input a command to the apparatus.

### SUMMARY OF THE INVENTION

However, where a screen of the display panel is not so large or where buttons functioning as operational images are displayed densely on a small area, the user may unfortunately touches not only a button the user intends to touch, but also a button located near the button the user intends to touch by mistake.

This invention has been developed in view of the above-described situations, and it is an object of the present invention to provide an input apparatus configured to determine one button desired by a user as a selected button even where the user has unintentionally touched two or more buttons.

The object indicated above may be achieved according to the present invention which provides an input apparatus comprising: a display device configured to display a plurality of operational images respectively corresponding to predetermined commands; a touch detection device configured to detect a presence of a touch of an input object on each of the plurality of operational images displayed on the display device; an operational-image specifying section configured to specify each operational image the input object has touched among the plurality of operational images on the basis of the presence of the touch of the input object on each of the plurality of operational images, the presence having been detected by the touch detection device; an operational-image number judging section configured to judge whether two or more of the plurality of operational images have been specified by the operational-image specifying section or not; a selected-direction determining section configured to determine a direction selected by a direction selecting operation of the input object on a condition that the operational-image number judging section has judged that two or more of the plurality of operational images have been specified; and an operational-image determining section configured to determine one of the two or more operational images specified by the operational-image specifying section as a selected operational image of the input apparatus on the basis of the direction determined by the selected-direction determining section.

### BRIEF DESCRIPTION OF THE DRAWINGS

The objects, features, advantages, and technical and industrial significance of the present invention will be better understood by reading the following detailed description of embodiments of the invention, when considered in connection with the accompanying drawings, in which:

FIG. 1 is a block diagram showing an electric construction of an MFP as an embodiment of the present invention;

FIG. 2A is a view for explaining an example of a display displayed on an operational screen, FIG. 2B is a view for explaining a choice of candidates, FIG. 2C is a view for explaining a sliding operation, and FIG. 2D is a view for explaining a relationship between a sliding direction and a selected button;

FIG. 3A is a view schematically showing a relationship among a sliding-operation starting point, a sliding direction, and a central position of the candidates, and FIG. 3B is a view schematically showing a configuration of a direction management memory;

FIG. 4 is a flow-chart showing a selecting processing executed by a CPU of the MFP;

FIGS. 5A and 5B are views each for explaining an example in which three candidates are arranged so as to be adjacent to one another in one direction; and

FIG. 6 is a view showing an example in which a direction guide and an auxiliary guide are displayed on an operational screen in an MFP as a modification.

### DESCRIPTION OF THE EMBODIMENT

Hereinafter, there will be described an embodiment of the present invention by reference to the drawings.

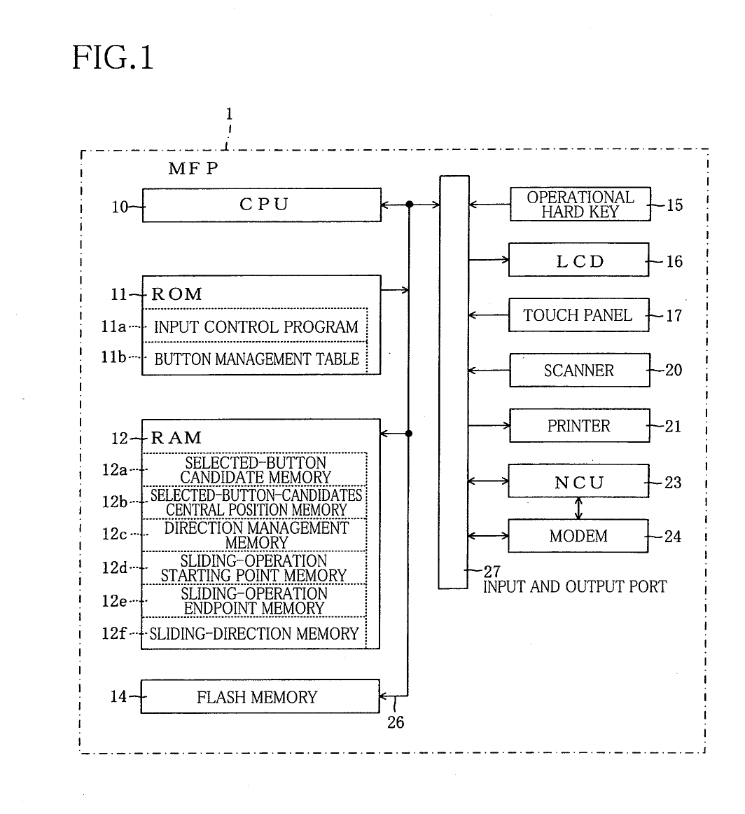

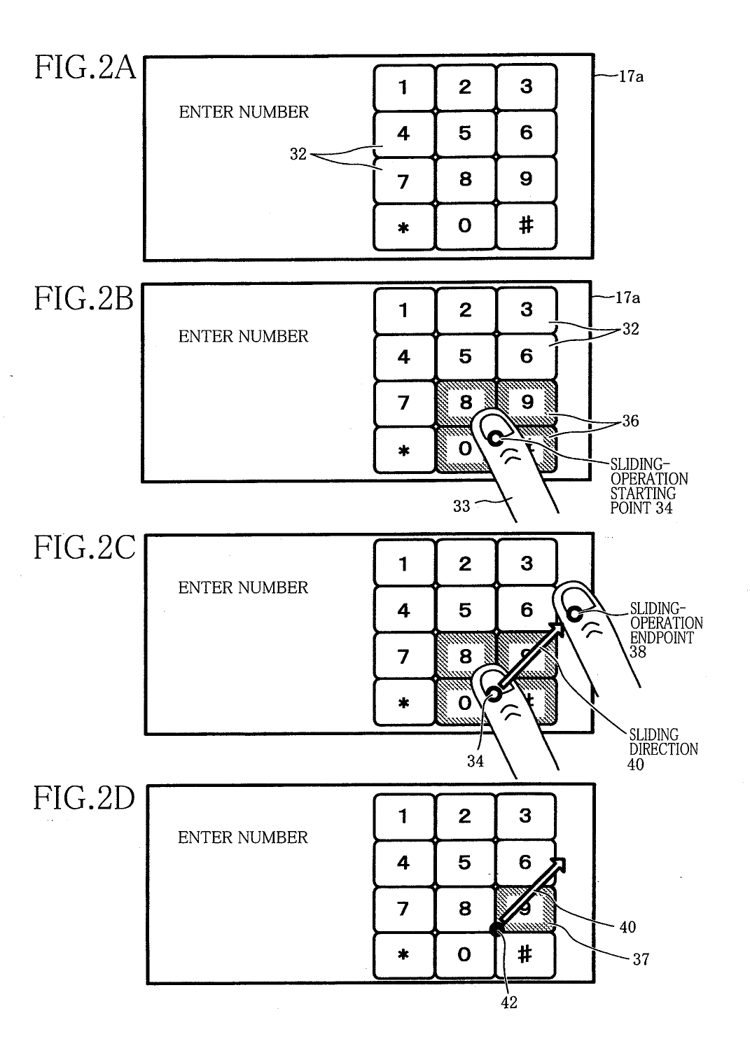

As shown in FIG. 1, a Multi Function Peripheral (MFP) 1 has various functions such as a copying function, a facsimile function, a scanning function, and a printing function. A plurality of operational images such as buttons 32 each functioning as a corresponding one of operational keys are displayed on a Liquid Crystal Display (LCD) 16 of the MFP 1, which will be explained in more detail with reference to FIGS. 2A-2D. When a user has touched or pressed one or ones of the buttons 32, the MFP 1 determines one of the touched button(s) as a selected button 37 and executes a processing associated in advance with the determined selected button 37. In particular, the MFP 1 as the present embodiment is configured such that even where the user has unintentionally touched two or more buttons, the user can determine a desired one of the buttons as the selected button 37. It is noted that to each of the buttons 32 is assigned a corresponding one of buttons used for input operations such as various operating commands and an input of a character. For example, the buttons 32 include: operational command input buttons for, e.g., starting printing (recording) and canceling printing; number input buttons for inputting numbers such as “0”, “1”, and “2”; character input buttons for inputting characters such as “a”, “b”, and “c”; and an arrow input button for moving a cursor displayed on the LCD 16. Hereinafter, this MFP 1 will be explained in more detail.

The MFP 1 mainly includes a CPU 10, a ROM 11, a RAM 12, a flash memory 14, operational hard keys 15, the LCD 16, a touch panel 17, a scanner 20, a printer 21, an NCU 23, and a modem 24. The CPU 10, the ROM 11, the RAM 12, and the flash memory 14 are connected to one another via a bus line 26. The operational hard keys 15, the LCD 16, the touch panel 17, the scanner 20, the printer 21, the NCU 23, the modem 24, and the bus line 26 are connected to one another via an input and output port 27.

The CPU 10 is configured to control the various functions of the MFP 1 and the various portions of the MFP 1 which are connected to the input and output port 27, in accordance with fixed values and programs stored in the ROM 11, the RAM 12, or the flash memory 14 or in accordance with various signals transmitted and received via the NCU 23.

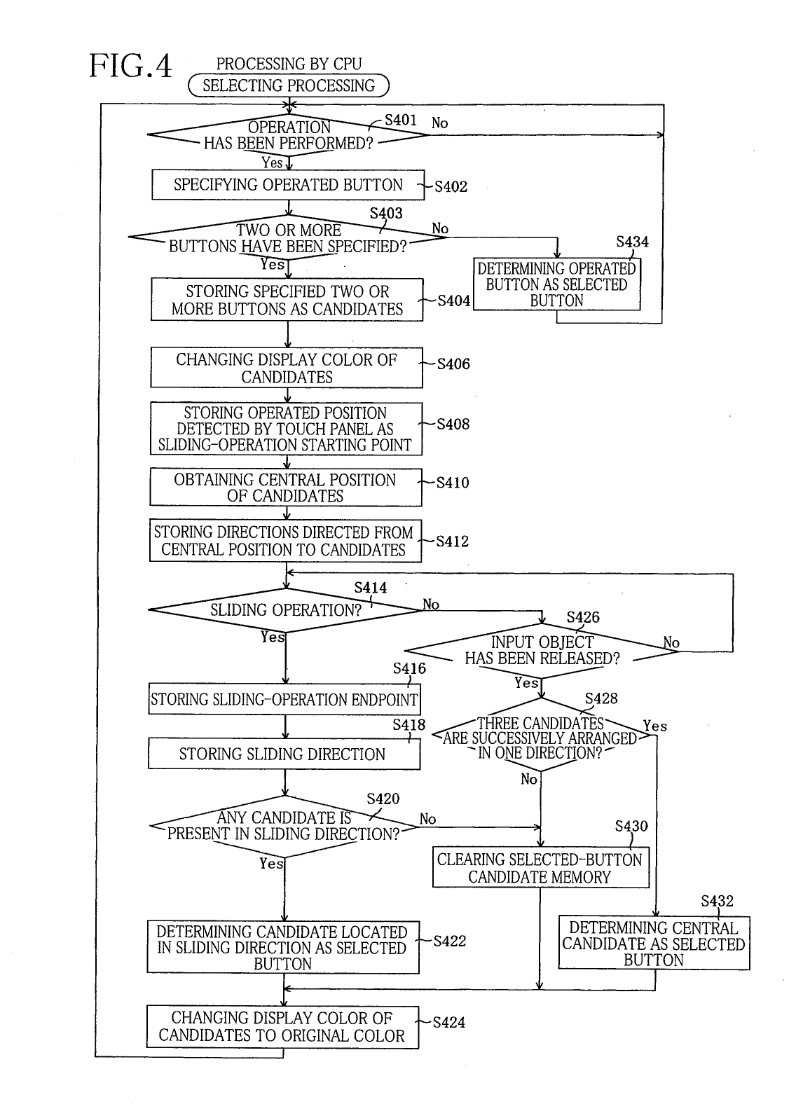

The ROM 11 is an unrewritable memory which stores, e.g., an input control program 11a and a button management table 11b. The CPU 10 executes a selecting processing (with reference to FIG. 4) which will be described below, in accordance with the input control program 11a. The button management table 11b is a table storing display areas each set in advance for a corresponding one of the buttons 32 (with reference to FIGS. 2A-2D) displayed on the LCD 16.

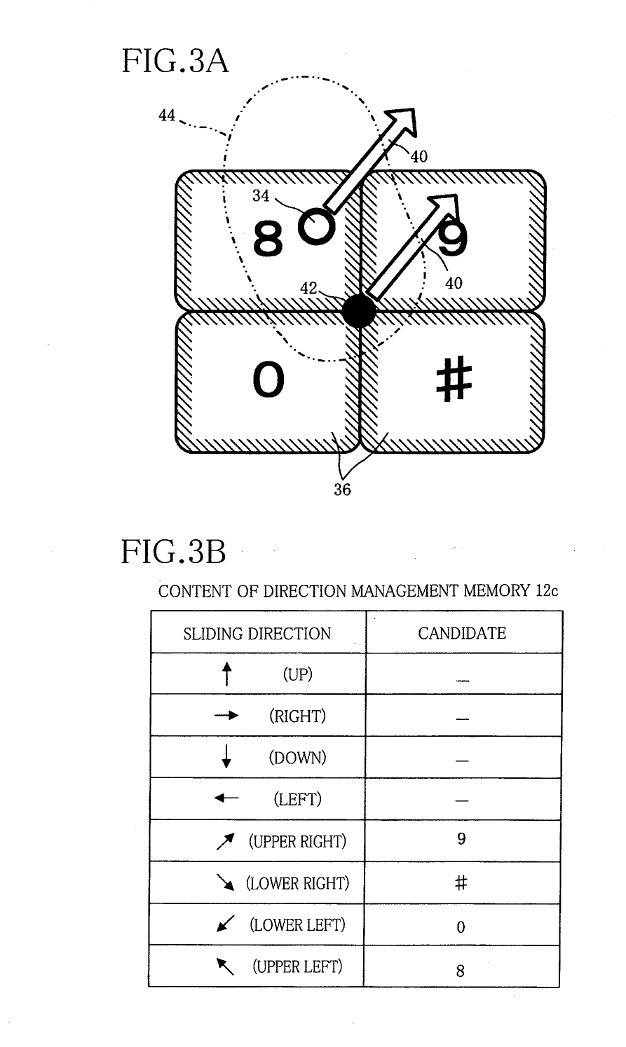

The RAM 12 is a rewritable volatile memory and includes a selected-button candidate memory 12a, a selected-button-candidates central position memory 12b, a direction management memory 12c, a sliding-operation starting point memory 12d, a sliding-operation endpoint memory 12e, and a sliding-direction memory 12f.

Where two or more of the buttons 32 (with reference to FIGS. 2A-2D) displayed on the LCD 16 have been touched or operated, the MFP 1 chooses the touched two or more buttons 32 as selected-button candidates 36, which will be explained in more detail with reference to FIGS. 2A-2D. The selected-button candidate memory 12a stores the chosen selected-button candidates 36. The selected-button-candidates central position memory 12b stores a central position 42 (with reference to FIG. 2D) of the two or more buttons 32 chosen as the selected-button candidates 36. The direction management memory 12c stores a positional or directional relationship between each of the selected-button candidates 36 and the central position 42 of the selected-button candidates 36, that is, the direction management memory 12c stores directions directed from the central position 42 toward the selected-button candidates 36. The direction management memory 12c will be explained in detail with reference to FIG. 3B.

After the choice of the two or more candidates, when the user has performed a sliding operation in which the user slides an input object such as his or her finger on the LCD 16, the MFP 1 determines as the selected button 37 one of the selected-button candidates 36 which is located at a position corresponding to a direction determined on the basis of the sliding operation. The sliding-operation starting point memory 12d stores a sliding-operation starting point 34 (with reference to FIGS. 2B and 2C) corresponding to a starting point of the sliding operation. The sliding-operation endpoint memory 12e stores a sliding-operation endpoint 38 (with reference to FIG. 2C) corresponding to an endpoint of the sliding operation. The sliding-direction memory 12f stores a sliding direction 40 (with reference to FIGS. 2C and 2D) determined on the basis of the sliding-operation starting point 34 and the sliding-operation endpoint 38.

The flash memory 14 is a rewritable nonvolatile memory. Each of the operational hard keys 15 is a physical key for inputting a command to the MFP 1. The LCD 16 is a liquid crystal display as a display device configured to display thereon various images such as the buttons 32.

The touch panel 17 is a touch detection device provided on the display areas of the LCD 16. A surface of the LCD 16 on which the touch panel 17 is provided will be hereinafter referred to as an operational screen (a touch face) 17a (with reference to FIGS. 2A-2D). When the user has touched the operational screen with an input object 33 (with reference to FIGS. 2B and 2C) such as his or her finger, the touch panel 17 detects a position (i.e., an operated position) of the touch of the user. Specifically, an entire area of the touch panel 17 is finely divided in a lattice shape into unit areas in each of which an electrostatic sensor is provided. Coordinates information (an x coordinate and a y coordinate) is brought into correspondence with each unit area on the basis of a coordination system in which a left top of the touch panel 17 is defined as an origin point, a rightward direction is defined as an X-direction, and a downward direction is defined as a Y-direction. Accordingly, the touch panel 17 detects presence of the touch of the input object 33 (with reference to FIGS. 2B and 2C) for each unit area and outputs as the operated position the coordinates information of all the unit area(s) on which the touch of the input object 33 has been detected.

It is noted that the touch panel 17 may be superposed or overlaid on the LCD 16 so as to be held in close contact with the LCD 16. Alternatively, the touch panel 17 may be superposed on the LCD 16 with a space formed therebetween or a transparency film interposed therebetween, for example.

The scanner 20 is configured to read a document in the facsimile function, the scanning function, or the copying function. The printer 21 is configured to record an image on a recording sheet. The NCU 23 is configured to control a telephone line. The modem 24 is configured to, in transmission of the facsimile, modulate a transmission signal to a form suitable for the transmission in the telephone line, and in receiving of the facsimile, demodulate the modulated signal transmitted from the telephone line.

There will be next explained how the MFP 1 determines one button desired by the user as the selected button where the user has touched two or more buttons 32 in the MFP 1 with reference to FIGS. 2A-2D.

As shown in FIG. 2A, the buttons 32 are arranged so as to be adjacent to one another in the present embodiment. When the user has touched one of the buttons 32 with the input object 33 such as his or her finger, the MFP 1 determines the touched button 32 as the selected button 37. Then, the MFP 1 inputs a value assigned in advance to the selected button 37 or executes a processing assigned in advance to the selected button 37.

As shown in FIG. 2B, where the operational screen 17a has been operated, the MFP 1 specifies as the touched button(s) 32 one(s) of the buttons 32 located at a position(s) at which the touch of the input object 33 has been detected. More specifically, the MFP 1 specifies, as the touched button(s), all one(s) of the buttons 32 included in the unit area(s) having detected the touch of the input object 33. Where the user has touched two or more buttons 32, the MFP 1 chooses the touched two or more buttons 32 as the selected-button candidates 36.

For example, where the user who intends to touch only the button 32 for inputting “9” has touched four buttons 32 by mistake, as shown in FIG. 2B, the MFP 1 chooses the touched four buttons 32 as the selected-button candidates 36. FIG. 2B shows a state in which the four buttons 32 for inputting “9”, “8”, “0”, and “#” are chosen as the selected-button candidates 36. The MFP 1 changes a display manner (e.g., a display color) of the buttons 32 chosen as the selected-button candidates 36 such that the display manner of the buttons 32 chosen as the selected-button candidates 36 is different from that of the other buttons 32 not chosen as the selected-button candidates 36. Accordingly, the user can recognize which buttons 32 have been chosen as the selected-button candidates 36 at a glance.

Then, the user performs the sliding operation for determining the selected button 37. Here, the sliding operation is an operation in which the user moves the input object 33 in a state in which the input object 33 is held in contact with the operational screen 17a. As shown in FIG. 2C, the MFP 1 determines the sliding direction 40 on the basis of a direction of the movement of the input object 33 in this sliding operation. Then, as shown in FIG. 2D, the MFP 1 determines as the selected button 37 one of the selected-button candidates 36 which is located at a position toward which the sliding direction 40 is directed from a starting point of the movement of the input object.

As thus described, according to the MFP 1 as the present embodiment, even where the user has unintentionally touched two or more buttons, one of the buttons which is desired by the user can be determined as the selected button 37.

Explained more specifically, as shown in FIG. 2B, where the sliding operation has been performed, the MFP 1 obtains the sliding-operation starting point 34 corresponding to the starting point of the sliding operation. Then, as shown in FIG. 2C, where the input object 33 has been released or disengaged from the operational screen 17a after the sliding operation, the MFP 1 obtains the sliding-operation endpoint 38 corresponding to an endpoint of the sliding operation.

Here, obtaining the sliding-operation starting point 34 or the sliding-operation endpoint 38 means obtaining the coordinates information corresponding to the sliding-operation starting point 34 or the sliding-operation endpoint 38 on the basis of the coordinates information outputted from the touch panel 17. It is noted that where the touch of the input object 33 has been detected in ones of the unit areas of the touch panel 17, the MFP 1 obtains coordinates information corresponding to a center of the areas in which the touch has been detected, as the sliding-operation starting point 34 or the sliding-operation endpoint 38.

Then, the MFP 1 determines as the sliding direction 40 a direction corresponding to a vector directed from the sliding-operation starting point 34 to the sliding-operation endpoint 38. As shown in FIG. 2D, the MFP 1 determines as the selected button 37 one of the selected-button candidates 36 which is located at a position to which the sliding direction 40 is directed from the central position 42 of the four selected-button candidates 36.

Thus, even where the user has unintentionally touched ones of the buttons 32, the user can determine the desired button 32 as the selected button 37 by sliding the input object 33 in a direction toward the desired button 32 while touching the input object 33 on the operational screen 17a. Consequently, the operated position is less likely to be displaced and an operating error is less caused when compared with a case where the input object 33 is temporarily moved away or floated from the operational screen 17a after the choice of the selected-button candidates 36, and then the user has touched the operational screen 17a again with the input object 33.

Further, where the user has unintentionally touched ones of the buttons 32, the user can determine the selected button 37 by the sliding operation in such a manner that the input object 33 is returned to a position originally to be touched. Accordingly, the operation method is intuitive, thereby making it easier for the user to understand the operation method.

Further, according to the MFP 1, since the sliding direction 40 is determined on the basis of the sliding-operation starting point 34 and the sliding-operation endpoint 38 regardless of a midway path of the sliding operation, it is easy for the user to select a desired direction. For example, where the user has changed his or her mind during the sliding operation, the user can determine the selected button 37 by changing a sliding direction while the input object 33 is being held in contact with the operational screen 17a and then continuing the sliding operation in a direction toward the desired button 32.

There will be next explained a relationship between the selected-button candidates 36 and the sliding direction 40 with reference to FIGS. 3A and 3B. It is noted that, in FIG. 3A, an area in which the touch of the input object 33 has been detected on the operational screen 17a is illustrated as an area 44 by a two-dot chain line. Where the touch of the input object 33 has been detected on ones of the unit areas of the touch panel 17, the MFP 1 obtains coordinates information of a center of the area 44 as the sliding-operation starting point 34.

Here, it is easier for the user to recognize or grasp which selected-button candidate 36 is positioned in each direction from the central position 42 of the selected-button candidates 36 than to grasp which selected-button candidate 36 is positioned in each direction from the sliding-operation starting point 34. Further, as shown in FIG. 3A, no selected-button candidates 36 may be present in the sliding direction 40 in certain positions of the sliding-operation starting point 34.

Thus, the MFP 1 determines as the selected button 37 one of the selected-button candidates 36 that is located at a position toward which the sliding direction 40 is directed from the central position 42 of the selected-button candidates 36. In this configuration of the MFP 1, it is easy for the user to understand a correspondence or a relationship between each of the selected-button candidates 36 and a corresponding one of the sliding directions 40, whereby the user can easily perform the sliding operation.

As shown in FIG. 3B, the direction management memory 12c stores the sliding directions 40 and the selected-button candidates 36 each of which is brought into correspondence with one of the sliding directions 40. In the present embodiment, the sliding directions 40 include eight directions, namely, “up”, “down”, “left”, “right”, “upper right”, “lower right”, “lower left”, and “upper left”. For example, as shown in FIG. 3A, where the selected-button candidates 36 are respectively located on an upper right side, a lower right side, a lower left side; and an upper left side of the central position 42 of the selected-button candidates 36, the direction management memory 12c stores the four selected-button candidates 36 such that each of the directions “upper right”, “lower right”, “lower left”, and “upper left” is brought into correspondence with one of the selected-button candidates 36 which is located at a position corresponding to said each direction. The direction management memory 12c does not store any selected-button candidates 36 in the directions “up”, “down”, “left”, and “right”.

The MFP 1 as the present embodiment determines one of the selected-button candidates 36 as the selected button 37 on the basis of the sliding direction 40 and the correspondence stored in the direction management memory 12c.

There will be next explained the selecting processing with reference to a flow-chart shown in FIG. 4. This selecting processing is a processing for determining one of the buttons 32 as the selected button 37.

Initially, in S401, the CPU 10 judges whether the operational screen 17a has been touched or not. Where the CPU 10 has judged that the operational screen 17a has not been touched (S401: No), the CPU 10 repeats the processing of S401. On the other hand, where the CPU 10 has judged that the operational screen 17a has been touched (S401: Yes), the CPU 10 specifies in S402 one or ones of the buttons 32 which has or have been touched with the input object 33 on the basis of the operated position detected by the touch panel 17. Then, in S403, the CPU 10 judges whether two or more of the buttons 32 have been specified or not.

Where the CPU 10 has judged that two or more of the buttons 32 have been specified (S403: Yes), the CPU 10 chooses in S404 the specified two or more buttons 32 as the selected-button candidates 36 and stores the buttons 32 chosen by the CPU 10 into the selected-button candidate memory 12a. Then, in S406, the CPU 10 changes a display color of the buttons 32 chosen as the selected-button candidates 36 such that the display color of the chosen buttons 32 is different from that of the other buttons 32 not chosen as the selected-button candidates 36.

Then, in S408, the CPU 10 obtains the operated position detected by the touch panel 17 as the sliding-operation starting point 34 and stores the obtained operated position into the sliding-operation starting point memory 12d. It is noted that where the touch of the input object 33 has been detected in a plurality of the unit areas of the touch panel 17, the CPU 10 obtains the coordinates information of the unit areas outputted from the touch panel 17 and calculates an average value of the x coordinates of the obtained coordinates information and an average value of the y coordinates of the obtained coordinates information. Then, the CPU 10 obtains the calculated average value of the x coordinate and the calculated average value of the y coordinate respectively as the x coordinate and the y coordinate of the sliding-operation starting point 34 and stores the obtained average values of the x coordinate and the y coordinate into the sliding-operation starting point memory 12d.

Then, in S410, the CPU 10 obtains the central position 42 of the two or more buttons 32 chosen as the selected-button candidates 36 and stores the obtained central position 42 into the selected-button-candidates central position memory 12b. Here, obtaining the central position 42 means obtaining coordinates information corresponding to the central position 42. For example, the CPU 10 calculates an X-directional center of an area constituted by the buttons 32 chosen as the selected-button candidates 36 and stores the calculated X-directional center as the x coordinate of the central position 42 into the selected-button-candidates central position memory 12b. Further, the CPU 10 calculates a Y-directional center of the area constituted by the buttons 32 chosen as the selected-button candidates 36 and stores the calculated Y-directional center as the y coordinate of the central position 42 into the selected-button-candidates central position memory 12b.

Then, in S412, the CPU 10 stores directions directed from the central position 42 to the selected-button candidates 36 into the direction management memory 12c. That is, the CPU 10 determines the correspondence between each of the selected-button candidates 36 and a corresponding one of the sliding directions 40 and stores the correspondence into the direction management memory 12c.

Then, in S414, the CPU 10 judges whether the sliding operation has been performed on the operational screen 17a or not. Where the CPU 10 has judged that the sliding operation has been performed (S414: Yes), the CPU 10 obtains in S416 the sliding-operation endpoint 38 and stores the obtained sliding-operation endpoint 38 into the sliding-operation endpoint memory 12e. It is noted that where the touch of the input object 33 has been detected in a plurality of the unit areas of the touch panel 17 after the completion of the sliding operation and immediately before the input object 33 has been released from the operational screen 17a, the CPU 10 obtains the coordinates information of the unit areas outputted from the touch panel 17 and calculates the respective average values of the x coordinate and the y coordinate. Then, the CPU 10 obtains the calculated average value of the x coordinate and the calculated average value of the y coordinate respectively as the x coordinate and the y coordinate of the sliding-operation endpoint 38 and stores the obtained average values of the x coordinate and the y coordinate into the sliding-operation endpoint memory 12e.

Then, in S418, the CPU 10 determines the sliding direction 40 and stores the determined sliding direction 40 into the sliding-direction memory 12f. That is, where the sliding operation is performed on condition that the selected-button candidates 36 have been chosen, the CPU 10 determines a direction selected by the sliding operation.

Then, in S420, the CPU 10 judges whether any of the selected-button candidates 36 is present at a position toward which the sliding direction 40 is directed or not. Where the CPU 10 has judged that no selected-button candidates 36 are present (S420: No), this selecting processing goes to S430 which will be described below.

On the other hand, where the CPU 10 has judged that any of the selected-button candidates 36 is present (S420: Yes), the CPU 10 determines in S422 one of the selected-button candidates 36 as the selected button 37 on the basis of the sliding direction 40. Then, in S424, the CPU 10 changes the display color of the selected-button candidates 36 to an original color, and this selecting processing returns to S401.

On the other hand, where the CPU 10 has judged that the sliding operation has not been performed (S414: No), the CPU 10 judges in S426 whether the input object 33 has been released from the operational screen 17a without the sliding operation or not. Where the CPU 10 has judged that the input object 33 has not been released without the sliding operation (S426: No), this selecting processing returns to S414.

On the other hand, where the CPU 10 has judged that the input object 33 has been released without the sliding operation (S426: Yes), the CPU 10 judges in S428 whether three selected-button candidates 36 are successively arranged in one direction or not. Where the CPU 10 has judged that three selected-button candidates 36 are not successively arranged in one direction (S428: No), the CPU 10 clears in S430 the selected-button candidate memory 12a, and this selecting processing goes to S424. That is, the CPU 10 returns a state of the buttons 32 chosen as the selected-button candidates 36 to a normal state, i.e., a state of non-candidates. Thus, where the selected-button candidates 36 are candidates not desired by the user, the user can return the state of the buttons 32 chosen as the selected-button candidates 36 to the non-candidate state by the easy operation in which the input object 33 has been released from the operational screen 17a without the sliding operation.

On the other hand, where the CPU 10 has judged that three selected-button candidates 36 are successively arranged in one direction (S428: Yes), the CPU 10 determines in S432 a central one of the three selected-button candidates 36 as the selected button 37, and this selecting processing goes to S424.

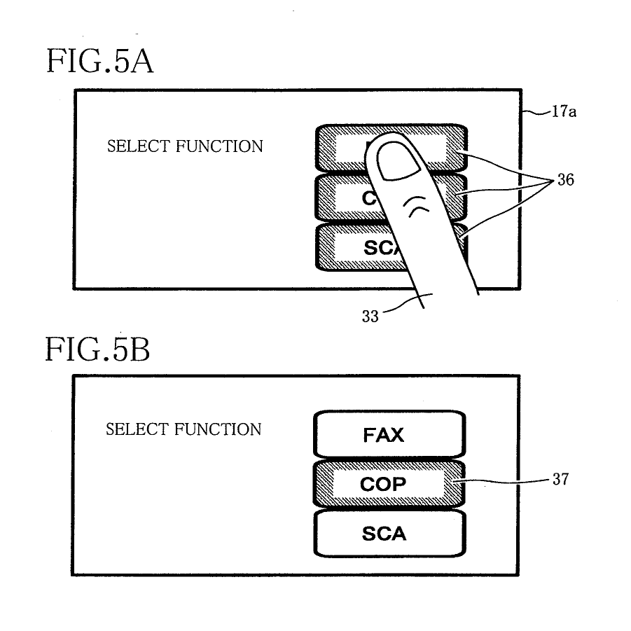

There will be next explained an example in which three selected-button candidates 36 are successively arranged in one direction with reference to FIGS. 5A and 5B. In the case where three selected-button candidates 36 are successively arranged in one direction as shown in FIG. 5A, where the user intends to select a central one of the selected-button candidates 36, the user performs the easy operation in which the input object 33 has been released from the operational screen 17a without the sliding operation, thereby determining the central selected-button candidate 36 as the selected button 37 as shown in FIG. 5B.

It is noted that where the CPU 10 has specified one button 32 as the touched button 32 in the selecting processing shown in FIG. 4, a negative decision is made in the judgment in S403 (S403: No). Thus, in S434, the CPU 10 determines the specified one button 32 as the selected button 37, and the selecting processing returns to S401.

In view of the above, the CPU 10 can be considered to include an operational-image specifying section configured to specify each button 37 the input object 33 has touched among the buttons 37 on the basis of the presence of the touch of the input object 33 on each button 37, and this operational-image specifying section can be considered to perform the processing of S402. Further, the CPU 10 can be considered to include an operational-image number judging section configured to judge whether two or more buttons 37 have been specified or not, and this operational-image number judging section can be considered to perform the processing of S403. Further, the CPU 10 can be considered to include a selected-direction determining section configured to determine a direction selected by the direction selecting operation on a condition that two or more buttons 37 have been specified, and this selected-direction determining section can be considered to perform the processing of S418. Further, the CPU 10 can be considered to include an operational-image determining section configured to determine one of the two or more buttons 37 as the selected button 37 on the basis of the direction determined by the selected-direction determining section, and this operational-image determining section can be considered to perform the processing of S422.

Further, the CPU 10 can be considered to include a candidates choosing section configured to, where two or more buttons 37 have been specified, choose the specified two or more buttons 37 respectively as selected-button candidates 36, and this candidates choosing section can be considered to perform the processing of S404. Further, the CPU 10 can be considered to include a direction-operation judging section configured to judge whether the direction selecting operation has been performed or not on a condition that the selected-button candidates 36 have been chosen, and this direction-operation judging section can be considered to perform the processing of S414. Further, the CPU 10 can be considered to include a starting-point obtaining section configured to obtain the sliding-operation starting point, and this starting-point obtaining section can be considered to perform the processing of S408. Further, the CPU 10 can be considered to include an endpoint obtaining section configured to obtain the sliding-operation endpoint, and this endpoint obtaining section can be considered to perform the processing of S416.

Further, the CPU 10 can be considered to include a release judging section configured to judge whether or not the input object 33 has been released from the operational screen 17a without the sliding operation, and this release judging section can be considered to perform the processing of S426. Further, the CPU 10 can be considered to include a candidate canceling section configured to return a state of the buttons 37 chosen by the candidates choosing section to a state in which the buttons 37 are not the selected-button candidates 36, where the input object 33 has been released from the operational screen 17a without the sliding operation, and this candidate canceling section can be considered to perform the processing of S430. Further, the CPU 10 can be considered to include a central position obtaining section configured to obtain the central position 42, and this central position obtaining section can be considered to perform the processing of S410.

Further, the CPU 10 can be considered to include an operational-image presence judging section configured to judge whether or not any of the buttons 37 respectively chosen as the selected-button candidates 36 is present on a position toward which the direction determined by the selected-direction determining section is directed from the central position 42, and this operational-image presence judging section can be considered to perform the processing of S420. Further, the CPU 10 can be considered to include a display-manner changing section configured to change the display manner of the two or more buttons 37 respectively chosen as the selected-button candidates 36 to the display manner different from that of at least one of the buttons 37 which has not been chosen as the selected-button candidates 36, and this display-manner changing section can be considered to perform the processing of S406.

While the embodiment of the present invention has been described above, it is to be understood that the invention is not limited to the details of the illustrated embodiment, but may be embodied with various changes and modifications, which may occur to those skilled in the art, without departing from the spirit and scope of the invention.

For example, the correspondence between each selected-button candidate 36 and the corresponding sliding direction 40 may be displayed on the operational screen 17a in order for the user to grasp the correspondence more easily.

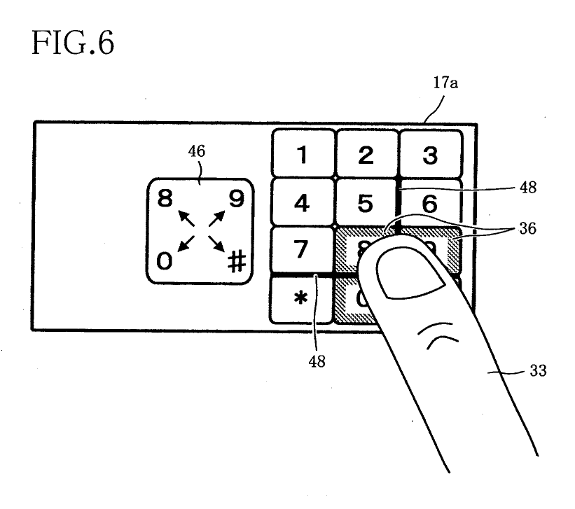

There will be next explained an example in which a direction guide 46 is displayed on the operational screen 17a in the MFP 1 as a modification with reference to FIG. 6. As shown in FIG. 6, the direction guide 46 indicates correspondences between each of directions the user may select and one of the buttons 32 which is to be determined as the selected button 37 where a corresponding direction has been selected. Where the MFP 1 is thus configured, even if the selected-button candidates 36 become hard to be seen by being hidden by the input object 33, the user can select an appropriate direction by referring the correspondence indicated by the direction guide 46. Where the MFP 1 as this modification is used, a processing for displaying the direction guide 46 is added to between S412 and S414 in the selecting processing (with reference to FIG. 4). In this case, the CPU 10 can be considered to include a correspondence display section configured to display the correspondences between directions the user may select and buttons 32 to be determined as the selected button 37 where each direction has been selected.

Further, as shown in FIG. 6, the MFP 1 as the modification may be configured such that an auxiliary guide 48 indicating a boundary of the selected-button candidates 36 is displayed. Where the MFP 1 is configured in this manner, the user can grasp which directions are selectable as the sliding direction 40.

Further, in the above-described embodiment, one of the eight directions “up”, “down”, “left”, “right”, “upper right”, “lower right”, “lower left”, and “upper left” is determined as the sliding direction 40, but the MFP 1 may be configured such that the user determines one of directions which are more than eight directions. The more the selectable directions are, the more accurately the user needs to perform the operation for selecting the direction. Even where the MFP 1 is thus configured, where one or both of the direction guide 46 and the auxiliary guide 48 is or are displayed on the operational screen 17a, the user can easily perform the operation for selecting the direction.

Further, while the present input apparatus has been explained by taking the MFP 1 as an example in the above-described embodiment, various devices such as a cellular phone device, an electronic game console, and a digital camera can be used as the input apparatus.

Further, while the direction selecting operation has been explained by taking the sliding operation as an example in the above-described embodiment, the direction selecting operation only needs a function for selecting the direction and is not limited to the sliding operation. For example, the direction selecting operation may be an operation in which the input object 33 is temporarily floated from the operational screen 17a and then brought into contact with another position on the operational screen 17a.

Further, one or ones of the buttons 32 the input object 33 has touched is or are specified as the touched or operated button(s) 32 in the above-described embodiment. However, the MFP 1 is not limited to this configuration. That is, the MFP 1 may be configured such that one or ones of the buttons 32 the input object 33 has approached is or are specified as the touched or operated button(s) 32, for example.

Further, in the above-described embodiment, the MFP 1 changes the display color of the buttons 32 chosen as the selected-button candidates 36 in order that the display manner of the buttons 32 chosen as the selected-button candidates 36 is made different from that of the other buttons 32 not chosen as the selected-button candidates 36. Instead of this configuration, the display manner may be changed in a different manner. For example, a shape of each button 32 chosen as the selected-button candidates 36 may be made different from the other buttons 32, or each button 32 chosen as the selected-button candidates 36 may light up.

It is noted that, in the above-described embodiment, the MFP 1 specifies the button(s) 32 operated by the input object 33 (in S402) and chooses the specified button(s) 32 as the candidates 36 for the selected button 37 (in S404), but the present invention is not limited to this configuration. For example, the MFP 1 may be configured to specify the buttons 32 operated by the input object 33 and determine the selected button 37 from the specified buttons 32 on the basis of the sliding direction 40.

What is claimed is:

1. An input apparatus comprising:
a display device configured to display a plurality of operational images respectively corresponding to predetermined commands;
a touch detection device configured to detect a presence of a touch of an input object on each of the plurality of operational images displayed on the display device;
an operational-image specifying section configured to specify each operational image the input object has touched among the plurality of operational images on the basis of the presence of the touch of the input object on each of the plurality of operational images, the presence having been detected by the touch detection device;
an operational-image number judging section configured to judge whether two or more of the plurality of operational images have been specified by the operational-image specifying section or not;
a selected-direction determining section configured to determine a direction selected by a direction selecting operation of the input object on a condition that the operational-image number judging section has judged that two or more of the plurality of operational images have been specified; and
an operational-image determining section configured to determine one of the two or more operational images specified by the operational-image specifying section as a selected operational image of the input apparatus on the basis of the direction determined by the selected-direction determining section.

2. The input apparatus according to claim 1, further comprising a candidates choosing section configured to, where the operational-image number judging section has judged that two or more of the plurality of operational images have been specified by the operational-image specifying section, choose the specified two or more operational images respectively as selected-operational-image candidates of the input apparatus,
wherein the operational-image determining section is configured to determine one of the selected-operational-image candidates chosen by the candidates choosing section as the selected operational image on the basis of the direction determined by the selected-direction determining section.

3. The input apparatus according to claim 2, further comprising a direction-operation judging section configured to judge whether the direction selecting operation of the input object has been performed or not on a condition that the selected-operational-image candidates have been chosen by the candidates choosing section,
wherein the selected-direction determining section is configured to determine the direction selected by the direction selecting operation of the input object on a condition that the direction selecting operation of the input object has been performed.

4. The input apparatus according to claim 2,
wherein the touch detection device has a touch face the input object touches, and
wherein the selected-direction determining section is configured to determine the direction selected by the direction selecting operation of the input object on the basis of a direction of a movement of the input object in a sliding operation as the direction selecting operation, the sliding operation being an operation in which the input object is moved while touching the touch face.

5. The input apparatus according to claim 4, further comprising:
a starting-point obtaining section configured to obtain a sliding-operation starting point corresponding to a starting point of the sliding operation; and
an endpoint obtaining section configured to obtain a sliding-operation endpoint corresponding to an endpoint of the sliding operation,
wherein the selected-direction determining section is configured to determine, as the direction selected by the direction selecting operation of the input object, a direction corresponding to a vector directed from the sliding-operation starting point obtained by the starting-point obtaining section to the sliding-operation endpoint obtained by the endpoint obtaining section.

6. The input apparatus according to claim 4, further comprising:
a release judging section configured to judge whether or not the input object has been released from the touch face without a performance of the sliding operation on a condition that the candidates choosing section has chosen the selected-operational-image candidates; and
a candidate canceling section configured to return a state of the operational images chosen by the candidates choosing section to a state in which the operational images are not the selected-operational-image candidates, where the release judging section has judged that the input object has been released from the touch face without a performance of the sliding operation.

7. The input apparatus according to claim 4, further comprising a release judging section configured to judge whether or not the input object has been released from the touch face without a performance of the sliding operation on a condition that the candidates choosing section has chosen the selected-operational-image candidates,
wherein where three selected-operational-image candidates chosen by the candidates choosing section are successively arranged in a certain direction on the touch face in a case where the release judging section has judged that the input object has been released from the touch face without a performance of the sliding operation, the operational-image determining section is configured to determine a central one of the three selected-operational-image candidates as the selected operational image.

8. The input apparatus according to claim 2, further comprising a central position obtaining section configured to obtain a central position of the two or more operational images respectively chosen as the selected-operational-image candidates by the candidates choosing section,
wherein the operational-image determining section is configured to determine one of the selected-operational-image candidates chosen by the candidates choosing section as the selected operational image, the one being located at a position toward which the direction determined by the selected-direction determining section is directed from the central position obtained by the central position obtaining section.

9. The input apparatus according to claim 8, further comprising:
an operational-image presence judging section configured to judge whether or not any of the operational images respectively chosen as the selected-operational-image candidates by the candidates choosing section is present on a position toward which the direction determined by the selected-direction determining section is directed from the central position obtained by the central position obtaining section; and
a candidate canceling section configured to return a state of the operational images chosen by the candidates choosing section to a state in which the operational images are not the selected-operational-image candidates, where the operational-image presence judging section has judged that the selected-operational-image candidates chosen by the candidates choosing section are not present on the position toward which the direction determined by the selected-direction determining section is directed from the central position.

10. The input apparatus according to claim 1, further comprising a correspondence display section configured to display correspondences between directions selectable by the direction selecting operation and the operational images to be determined as the selected operational image where each of the selectable directions has been selected.

11. The input apparatus according to claim 1, further comprising a display-manner changing section configured to change a display manner of the two or more operational images respectively chosen as the selected-operational-image candidates by the candidates choosing section to a display manner different from that of at least one of the plurality of operational images which has not been chosen as the selected-operational-image candidates.
